(19) United States
(12) Patent Application Publication
(10) Pub. No.: US 2019/0354246 A1
(43) Pub. Date: Nov. 21, 2019

(54) AIRPORT ROBOT AND MOVEMENT METHOD THEREFOR

(71) Applicant: LG ELECTRONICS INC., Seoul (KR)

(72) Inventor: Jungmin PARK, Seoul (KR)

(73) Assignee: LG ELECTRONICS INC., Seoul (KR)

(21) Appl. No.: 16/473,223

(22) PCT Filed: Dec. 11, 2017
(86) PCT No.: PCT/KR2017/014491

§ 371 Date: Jun. 24, 2019

(30) Foreign Application Priority Data
Dec. 23, 2016 (KR) 10-2016-0178443

(51) Int. Cl. G06F 3/0482; G06F 3/14; G06F 3/0484; B25J 13/08; B25J 13/06

(52) U.S. Cl. CPC G06F 3/0482; G06F 3/14; G05D 1/0212; B25J 13/086; B25J 13/06; G06F 3/0484

(57) ABSTRACT

The disclosure includes a robot including a display unit, a sensor, and one or more processors configured to detect an object proximately positioned from the display unit via the sensor, determine a first position associated with the detected object relative to the display unit, display, via the display unit, first information for the detected object at the determined first position, and display, via the display unit, second information for the detected object at a second position on the display unit, wherein the displayed second information comprises a button associated with the displayed first information.

### CROSS-REFERENCE TO RELATED APPLICATIONS

This application is the National Stage filing under 35 U.S.C. 371 of International Application No. PCT/KR2017/014491, filed on Dec. 11, 2017, which claims the benefit of earlier filing date and right of priority to Korean Application No. 10-2016-0178443, filed on Dec. 23, 2016, the contents of which are hereby incorporated by reference herein in its entirety.

### TECHNICAL FIELD

The present invention relates to a robot and a method for operating the same, and more particularly, to a guide robot which provides guidance to users, and an operating method therefor.

### BACKGROUND

The application fields of robots are generally classified into various categories, including industrial robots, medical robots, universal robots, personal robots, and seabed robots. For example, in machine processing industry such as production of vehicles, robots may perform automated work. That is, industrial robots may be programmed to learn an operation performed by humans and to repeat the same operations for purposes of mass manufacturing, and the like.

In some robots, a sensor may transmit a signal including an ultrasonic wave or an infrared ray and receive a reflected wave signal reflected by an object, in order to recognize a presence or approach of an object.

Such a sensor is applied to proximity sensing systems. For example, in automobiles, proximity sensing systems having a sensor may be installed on the vehicle bumper or sides so as to prevent vehicle collision, and to detect and notify the user when an object or person approaches the vehicle.

When such a sensor is applied to a display device, it is possible to detect that an object or a part of the body of the user is in proximity or contact with the display device through the sensor.

### SUMMARY

An object of the present invention is to provide a function of automatically activating an operation menu of a display unit of a robot without a user's manual operation. Another object of the present invention is to allow the user to intuitively recognize whether the operation menu of the robot is in an active state.

An embodiment of the present disclosure includes a robot including a display unit configured to display information, a sensor, and one or more processors configured to detect an object proximately positioned from the display unit via the sensor, determine a first position associated with the detected object relative to the display unit, display, via the display unit, first information for the detected object at the determined first position, and display, via the display unit, second information for the detected object at a second position on the display unit, wherein the displayed second information comprises a button associated with the displayed first information.

Another embodiment of the present disclosure includes a machine-readable non-transitory medium having stored thereon machine-executable instructions for controlling a robot, the instructions including detecting an object proximately positioned from the display unit, determining a first position associated with the detected object relative to the display unit, displaying, via a display unit of the robot, first information for the detected object at the determined first position, and displaying, via the display unit, second information for the detected object at a second position on the display unit, wherein the displayed second information comprises a button associated with the displayed first information.

Another embodiment of the present disclosure includes an electronic terminal including a display, one or more sensors, and one or more processors configured to detect an object proximately positioned from the display unit via the one or more sensors, determine a first position associated with the detected object relative to the display, display, via the display, first information for the detected object at the determined first position, and display, via the display, second information for the detected object at a second position on the display, wherein the displayed second information comprises a button associated with the displayed first information.

Another embodiment of the present disclosure includes means for detecting an object proximately positioned from the display unit, determining a first position associated with the detected object relative to the display unit, displaying, via a display unit of the robot, first information for the detected object at the determined first position, and displaying, via the display unit, second information for the detected object at a second position on the display unit, wherein the displayed second information comprises a button associated with the displayed first information.

### BRIEF DESCRIPTION OF THE DRAWINGS

FIG. 1 is a block diagram illustrating a hardware configuration of a robot according to an embodiment of the present invention.

FIG. 2 is a diagram illustrating in detail a configuration of each of a microcomputer and an application processor (AP) of a robot according to another embodiment of the present invention.

FIG. 3 is a diagram illustrating the structure of a robot system according to an embodiment of the present invention.

FIG. 4 is a diagram illustrating an example in which the robot according to the embodiment of the present invention detects a human body or an object at each predetermined distance.

FIG. 5 is a diagram illustrating an example in which a display device using proximity sensing according to an embodiment of the present invention is actually applied.

FIG. 6 is a block diagram illustrating a display device using proximity sensing according to an embodiment of the present invention.

FIG. 7 is a diagram illustrating an example in which a sensor illustrated in FIG. 6 is mounted on a display device.

FIG. 8 is a diagram illustrating another example in which a sensor illustrated in FIG. 6 is mounted on a display device.

FIG. 9 is a diagram for describing a method for detecting a position where a part of a body of a user approaches by using the sensor illustrated in FIG. 6.

FIG. 10 is a diagram for describing a method by which a button detection unit illustrated in FIG. 6 detects a button that is present at a position where a part of a body of a user approaches.

FIG. 11 is a diagram illustrating an example in which a button is detected in the display device by the button detection unit illustrated in FIG. 6.

FIG. 12 is a diagram for describing an operating method of an operable state detection unit illustrated in FIG. 6.

FIG. 13 is a diagram for describing an operating method of a preceding button searching unit illustrated in FIG. 6.

FIG. 14 is a diagram illustrating an example in which a preceding button is displayed on a display device.

FIG. 15 is a diagram illustrating an operating method of a state information searching unit illustrated in FIG. 6.

FIG. 16 is a diagram for describing an operating method of the state information searching unit illustrated in FIG. 6 when the button is operable.

FIG. 17 is a diagram for describing an operating method of the state information searching unit illustrated in FIG. 6 when the button is non-operable.

FIG. 18 is a flowchart illustrating a display control method using proximity sensing according to an embodiment of the present invention.

FIG. 19 is a flowchart illustrating a display control method using proximity sensing according to another embodiment of the present invention.

FIG. 20 is a flowchart illustrating a display control method using proximity sensing according to further another embodiment of the present invention.

FIG. 21 is a flowchart illustrating a display control method using proximity sensing when there is no state information corresponding to a function of a button illustrated in FIG. 19.

### DETAILED DESCRIPTION

Hereinafter, embodiments relating to the present invention will be described in detail with reference to the accompanying drawings.

The suffixes “module” and “unit” for components used in the description below are assigned or mixed in consideration of easiness in writing the specification and do not have distinctive meanings or roles by themselves.

In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Further, while the term “robot” is used in this disclosure, it will be understood by those of ordinary skill in the art that the disclosure is not limited to devices deemed solely with a robotic function or purpose, and that the embodiments of the present disclosure may be implemented with various other types of devices, terminals, and apparatuses, including various configurations and types of computers, electronic terminals, personal and home devices, appliances, and the like.

It will be understood that although the terms first, second, etc. may be used herein to describe various elements, these elements should not be limited by these terms. These terms are generally only used to distinguish one element from another.

It will be understood that if an element is referred to as being “connected to” or “coupled to” another element, the element can be directly connected with the other element or intervening elements may also be present. In contrast, if an element is referred to as being “directly connected to” or “directly coupled to” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

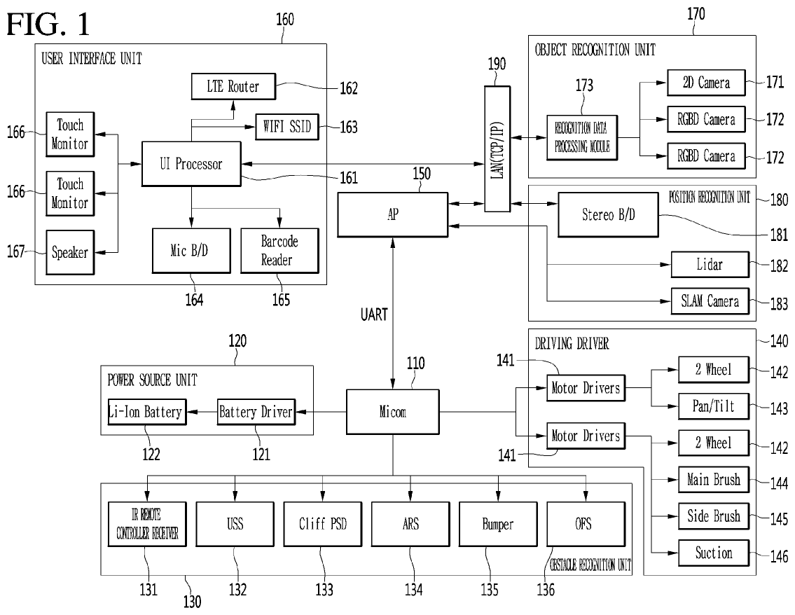

FIG. 1 is a block diagram illustrating a hardware configuration of a robot according to an embodiment of the present invention.

As illustrated in FIG. 1, hardware of the airport robot according to an embodiment of the present invention may be configured with a microcomputer group and an application processor (AP) group. The microcomputer group may include a microcomputer 110, a power source unit 120, an obstacle recognition unit 130, and a driving driver 140. The AP group may include an AP 150, a user interface unit 160, an object recognition unit 170, a position recognition unit 180, and a local area network (LAN) 190. The user interface unit 160 may be referred to as a communication unit.

The microcomputer 110 may manage the power source unit 120 including a battery of the hardware of the robot, the obstacle recognition unit 130 including various kinds of sensors, and the driving driver 140 including a plurality of motors and wheels.

The power source unit 120 may include a battery driver 121 and a lithium-ion (Li-ion) battery 122. The battery driver 121 may manage charging and discharging of the Li-ion battery 122. The Li-ion battery 122 may supply power for driving the airport robot. The Li-ion battery 122 may be configured by connecting two 24V/102A Li-ion batteries in parallel.

The obstacle recognition unit 130 may include an infrared (IR) remote controller reception unit 131, an ultrasonic sensor (USS) 132, a cliff PSD 133, an attitude reference system (ARS) 134, a bumper 135, and an optical flow sensor (OFS) 136. The IR remote controller reception unit 131 may include a sensor which receives a signal from an IR remote controller for remotely controlling the robot. The USS 132 may include a sensor for determining a distance between an obstacle and the robot by using an ultrasonic signal. The cliff PSD 133 may include a sensor for sensing a precipice or a cliff within a forward-direction airport robot driving range of 360 degrees. The ARS 134 may include a sensor for detecting a gesture of the airport robot. The ARS 134 may include a sensor which is configured with an acceleration 3-axis and a gyro 3-axis for detecting the number of rotations. The bumper 135 may include a sensor which senses a collision between the robot and an obstacle. The sensor included in the bumper 135 may sense a collision between the robot and an obstacle within a 360-degree range. The OFS 136 may include a sensor for measuring a phenomenon where a wheel is spinning in driving of the robot and a driving distance of the robot on various floor surfaces.

The driving driver 140 may include a motor driver 141, a wheel motor 142, a rotation motor 143, a main brush motor 144, a side brush motor 145, and a suction motor 146. The motor driver 141 may perform a function of driving the wheel motor, the brush motor, and suction motor for driving and cleaning operations of the robot. The wheel motor 142 may drive a plurality of wheels for driving of the robot. The rotation motor 143 may be driven for a lateral rotation and a vertical rotation of a head unit of the robot or a main body of the robot, or may be driven the direction change or rotation of a wheel of the robot. The main brush motor 144 may drive a brush which sweeps filth on an floor. The side brush motor 145 may drive a brush which sweeps filth in a peripheral area of an outer surface of the robot. The suction motor 146 may be driven for sucking filth on the airport floor.

The AP 150 may function as a central processing unit which manages a whole hardware module system of the robot. The AP 150 may transmit, to the microcomputer 110, user input/output information and application program driving information for driving by using position information obtained through various sensors, thereby allowing a motor or the like to be performed.

The user interface unit 160 may include a user interface (UI) processor 161, a long term evolution (LTE) router 162, a WIFI SSID 163, a microphone board 164, a barcode reader 165, a touch monitor 166, and a speaker 167. The user interface processor 161 may control an operation of the user interface unit which performs an input/output of a user. The LTE router 162 may receive necessary information from the outside and may perform LTE communication for transmitting information to the user. The WIFI SSID 163 may analyze WIFI signal strength to perform position recognition on a specific object or the robot. The microphone board 164 may receive a plurality of microphone signals, process a sound signal into sound data which is a digital signal, and analyze a direction of the sound signal and a corresponding sound signal. The barcode reader 165 may read barcode information described in a plurality of targets associated with data or locations sought by a user of the robot. The touch monitor 166 may include a monitor for displaying output information and a touch panel which is configured for receiving the input of the user. The speaker 167 may inform the user of specific information through a voice.

The object recognition unit 170 may include a two-dimensional (2D) camera 171, a red, green, blue, and distance (RGBD) camera 172, and a recognition data processing module 173. The 2D camera 171 may be a sensor for recognizing a person or an object on the basis of a 2D image. The RGBD camera 172 may be a camera including RGBD sensors or may be a sensor for detecting a person or an object by using captured images including depth data obtained from other similar three-dimensional (3D) imaging devices. The recognition data processing module 173 may process a signal such as 2D image/video or 3D image/video obtained from the 2D camera and the RGBD camera 172 to recognize a person or an object.

The position recognition unit 180 may include a stereo board (B/D) 181, a light detection and ranging (LIDAR) 182, and a simultaneous localization and mapping (SLAM) camera 183. The SLAM camera 183 may implement simultaneous position tracing and mapping technology. The robot may detect ambient environment information by using the SLAM camera 183 and may process obtained information to generate a map corresponding to a space for performing a duty and simultaneously estimate its absolute position. The LIDAR 182, a laser radar, may be a sensor which irradiates a laser beam and collects and analyzes rearward-scattered light of light absorbed or scattered by aerosol to perform position recognition. The stereo board 181 may process sensing data collected from the LIDAR 182 and the SLAM camera 183 to manage data for recognizing a position of the robot or obstacles.

The LAN 190 may perform communication with the user interface processor 161 associated with a user input/output, the recognition data processing module 173, the stereo board 181, and the AP 150.

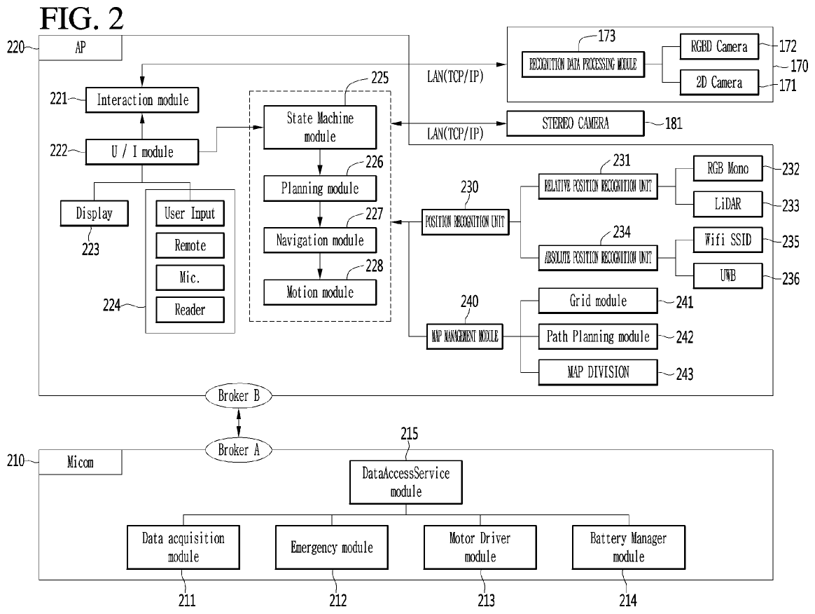

FIG. 2 is a diagram illustrating in detail a configuration of each of a microcomputer and an AP of a robot according to another embodiment of the present invention.

As illustrated in FIG. 2, a microcomputer 210 and an AP 220 may be implemented as various embodiments, for controlling recognition and action of the robot.

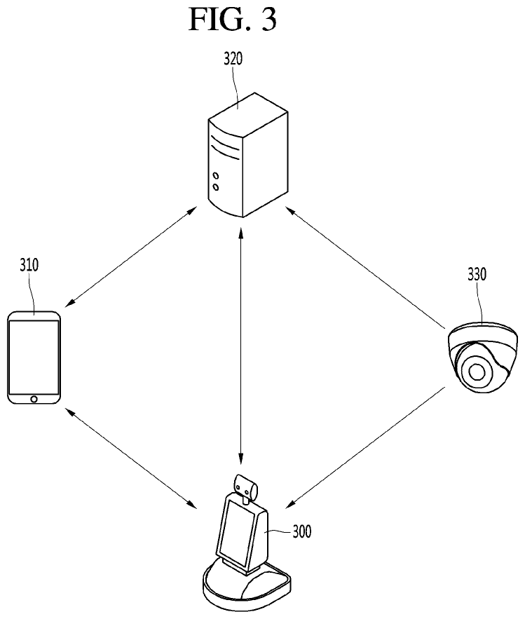

For example, the microcomputer 210 may include a data access service module 215. The data access service module 215 may include a data acquisition module 211, an emergency module 212, a motor driver module 213, and a battery manager module 214. The data acquisition module 211 may acquire data sensed from a plurality of sensors included in the robot and may transfer the acquired data to the data access service module 215. The emergency module 212 may be a module for sensing an abnormal state of the robot, and when the robot performs a predetermined type action, the emergency module 212 may sense that the robot is in the abnormal state. The motor driver module 213 may manage a wheel, a brush, and driving control of a suction motor for driving and cleaning of the robot. The battery manager module 214 may manage charging and discharging of the Li-ion battery 122 of FIG. 3 and may transfer a battery state of the robot to the data access service module 215.

The AP 220 may receive, recognize, and process a user input and the like to control an operation of the robot with various cameras and sensors. An interaction module 221 may be a module which synthesizes recognition data received from the recognition data processing module 173 and a user input received from a user interface module 222 to manage software exchanged between a user and the robot. The user interface module 222 may receive a close-distance command of the user such as via a key or button, a touch screen, a reader, or a display unit 223 which is a monitor for providing manipulation/information and a current situation of the robot, or may receive a long-distance signals such as a signal of an IR remote controller for remotely controlling the robot, or may manage a user input received via a user input unit 224 receiving an input signal of the user from a microphone, a barcode reader, or the like.

When one or more user inputs are received, the user interface module 222 may transfer user input information to a state machine module 225. The state machine module 225 which has received the user input information may manage a whole state of the robot and may issue an appropriate command corresponding to a user input. A planning module 226 may determine a start time and an end time/action for a specific operation of the robot according to the command transferred from the state machine module 225 and may calculate a path for movement of the robot through a particular location, a store, a park, an airport, an office, a home, or the like. A navigation module 227 may be a module which manages overall driving of the robot and may allow the robot to drive along a driving path calculated by the planning module 226. A motion module 228 may allow the robot to perform a basic operation in addition to driving.

Moreover, the robot according to another embodiment of the present invention may include a position recognition unit 230. The position recognition unit 230 may include a relative position recognition unit 231 and an absolute position recognition unit 234. The relative position recognition unit 231 may correct a movement amount of the robot through a RGB mono sensor 232, calculate a movement amount of the robot for a certain time, and recognize an ambient environment of the airport robot through a LIDAR 233. The absolute position recognition unit 234 may include a wireless fidelity service set identifier (WIFI SSID) 235 and an ultra wideband (UWB) 236. The WIFI SSID 235 may be an UWB sensor module for recognizing an absolute position of the robot and may be a WIFI module for estimating a current position through WIFI SSID sensing. The WIFI SSID 235 may analyze WIFI signal strength to recognize a position of the robot. The UWB 236 may calculate a distance between a transmission unit and a reception unit to sense the absolute position of the robot.

Moreover, the robot according to another embodiment of the present invention may include a map management module 240. The map management module 240 may include a grid module 241, a path planning module 242, and a map division module 243. The grid module 241 may manage a lattice type map generated by the robot through an SLAM camera or map data of an ambient environment, previously input to the robot, for position recognition. In map division for cooperation between a plurality of other robots, the path planning module 242 may calculate driving paths of the plurality of robots. Also, the path planning module 242 may calculate a driving path through which the robot will move. Also, the path planning module 242 may calculate a driving path through which the robot will move in an environment where one robot operates. The map division module 243 may calculate in real time an area which is to be managed by each of a plurality of robots.

Pieces of data sensed and calculated from the position recognition unit 230 and the map management module 240 may be again transferred to the state machine module 225. The state machine module 225 may issue a command to the planning module 226 so as to control an operation of the robot, based on the pieces of data sensed and calculated from the position recognition unit 230 and the map management module 240.

For the purposes of this discussion, various operations are discussed as being performed by various modules, units, or components of robot, such as data access service module, data acquisition module, emergency module, motor driver module, battery manager module, position recognition unit, map management module, state machine module, planning module, and the like. In some embodiments, a separate component of robot may be provided for one or more or each of the modules, units, or components to perform the disclosed operations. However it will also be understood that these and other components of this disclosure may be implemented with or as one or more hardware controllers or processors of the robot executing stored software instructions corresponding to the operations, or that one or more or all of the operations discussed with respect to these components may be performed by other aspects of robot, such as the one or more controllers or processors of the robot. Further, it will be understood that one or more or all of these operations may be performed via other means, including other terminals or apparatuses configured to perform the operations which are in communication with robot and configured to provide information resulting from said operations to the robot for further processing or use.

Next, FIG. 3 is a diagram illustrating the structure of an robot system according to an embodiment of the present invention.

The robot system according to the embodiment of the present invention may include a mobile terminal 310, a server 320, a robot 300 and a camera 330.

The mobile terminal 310 may transmit and receive data to and from the server 320. An example will be discussed in which the robot is implemented in an airport to provide guidance or information to travelers in the airport, or to perform certain tasks within the airport such as cleaning. It will be understood by those of ordinary skill that the disclosure is not limited thereto, and that the robot may be implemented in various types of locations and for various types of purposes.

In the airport example, the mobile terminal 310 may receive airport related data such as a flight time schedule, an airport map, etc. from the server 320. A user may receive necessary information of the airport from the server 320 through the mobile terminal 310. In addition, the mobile terminal 310 may transmit data such as a photo, a moving image, a message, etc. to the server 320. For example, the user may transmit the photograph of a missing child to the server 320 to report the missing child or photograph an area of the airport where cleaning is required through a camera to request cleaning of the area.

In addition, the mobile terminal 310 may transmit and receive data to and from the robot 300.

For example, the mobile terminal 310 may transmit, to the robot 300, a signal for calling the robot 300, a signal for instructing that specific operation is performed, or an information request signal. The robot 300 may move to the position of the mobile terminal 310 or perform operation corresponding to the instruction signal in response to the call signal received from the mobile terminal 310. Alternatively, the robot 300 may transmit data corresponding to the information request signal to the mobile terminal 310 of the user.

Next, the robot 300 may perform patrol, guidance, cleaning, disinfection and transportation within the airport.

The robot 300 may transmit and receive signals to and from the mobile terminal 310 or the server 320. For example, the robot 300 may transmit and receive signals including information on the situation of the airport to and from the server 320. In addition, the robot 300 may receive image information of the areas of the airport from the camera 330 in the airport. Accordingly, the robot 300 may monitor the situation of the airport through the image information captured by the robot 300 and the image information received from the camera 330.

The robot 300 may directly receive a command from the user. For example, a command may be directly received from the user through input of touching the display unit provided in the robot 300 or voice input. The robot 300 may perform patrol, guidance, cleaning, etc. according to the command received from the user, the mobile terminal 310 or the server 320.

Next, the server 320 may receive information from the mobile terminal 310, the robot 300, or the camera 330. The server 320 may collect, store and manage the information received from the devices. The server 320 may transmit the stored information to the mobile terminal 310 or the robot 300. In addition, the server 320 may transmit command signals to a plurality of robots 300 disposed throughout the airport.

The camera 330 may include a camera installed in the airport. For example, the camera 330 may include a plurality of closed circuit television (CCTV) cameras installed in the airport, an infrared thermal-sensing camera, etc. The camera 330 may transmit the captured image to the server 320 or the airport robot 300.

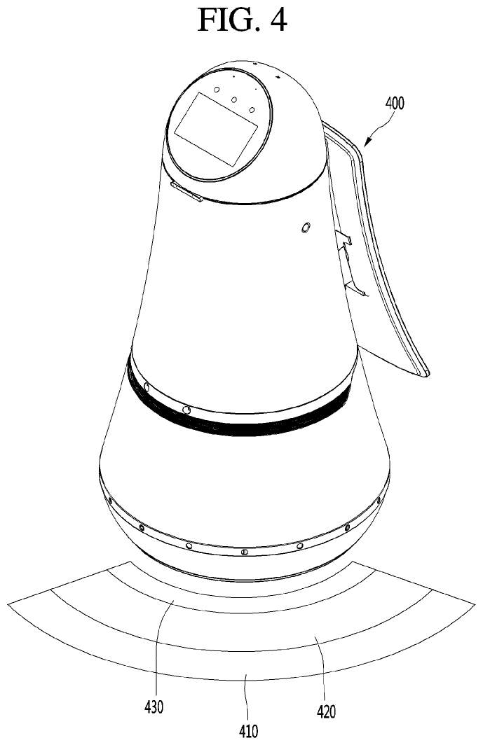

FIG. 4 is a diagram illustrating an example in which a robot according to the embodiment of the present invention detects a person or object located proximate to the robot.

As illustrated in FIG. 4, the robot 400 according to the embodiment of the present invention may activate different types of object recognition modes for each distance or predetermined range from the robot. For example, when a person or object is detected in a first range 410 from the robot, the user interface unit 160 of the robot 400 may automatically activate or “wake up”. When the user or object approaches the first range 410 from the robot 400, the user or object may interface with the robot without any manual operation to activate or wake up the robot 400.

In addition, when the person or object is detected in a second range 420 from the robot, the robot 400 can execute a mode for interfacing with the user if a person is detected. When the user is in the second range 420 from the robot, the robot 400 may deliver a message indicating that the interface is available without the user having to make a request by speaking, pressing any buttons, or inputting any other information to the robot. In addition, when the robot 400 detects that the user is within a third range 430 from the robot, the robot 400 may activate a risk mode. At this time, the robot 400 may output a warning sound to a speaker, or may output a warning message or the like to a monitor or display, thereby notifying the user that the user is positioned too close to the robot 400, or vice versa. When the user is no longer positioned within the third range 430 or the second range 420, the robot 400 may deactivate the risk mode and output a notification that the user is in a safe distance, or may simply stop outputting the previously output warning message. Alternatively, when the robot 400 detects that the user is within the third range 430, the robot 400 may move in a direction to keep a certain distance from the user so that the user is positioned within the second range 420 or further from the robot.

Furthermore, the robot 400 may provide the user with a guidance service for traveling to a specific destination. In this case, the robot 400 may move while continuing to sense the distance from the user so that the user is located within at least the first range 410. Therefore, the robot 400 may provide the guidance service while maintaining a distance from the user within a certain range.

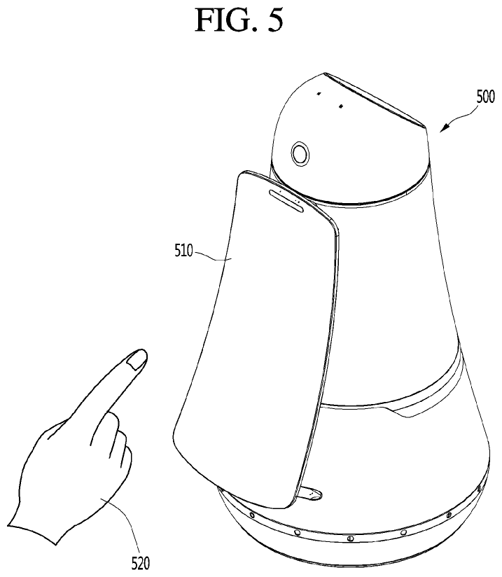

FIG. 5 is a diagram illustrating an example in which a display device using proximity sensing according to an embodiment of the present invention is applied.

As illustrated in FIG. 5, the robot 500 according to an embodiment of the present invention may include a rotatable display device 510. Therefore, when the user is detected within a predetermined distance from the robot, the display device 510 may perform an operation according to a predetermined algorithm.

The display device 510 using the proximity sensing according to the embodiment of the present invention may detect that a person or object approaches the display device 510. The display device 510 may detect a button displayed or located at a position close to or corresponding to the person or object (or part thereof, such as a finger 520) approaching the display device, and output an operation information signal for the detected button. Therefore, the user may be provided with operation guide information for the button that the finger of the user approaches or state information corresponding to the function of the button. A graphic icon displayed on a screen of the display device, and a touch button or a physical button provided on a portion of the display device other than the screen may be included.

The display device 510 using the proximity sensing according to the present invention may detect that the part of the body of the user (for example, a finger 520) approaches. When the button control device detects that the part of the body of the user approaches the display device, the display device may detect the button located at the position where the part of the body of the user is approaching. The display device may output an operation information signal for the detected button, in some cases at a position adjacent or different to the position where the button is located. At this time, the operation information signal may include function information corresponding to the button, operable state information of the button, and guide information for operating the button when the button is not operable.

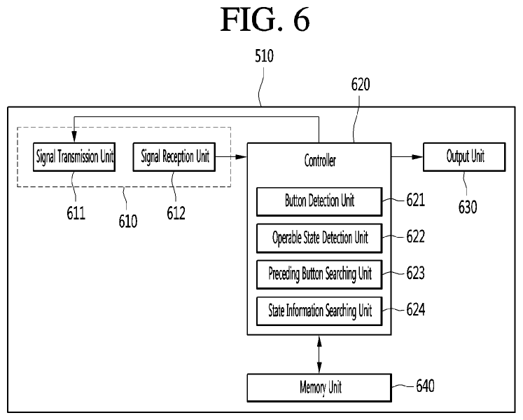

Referring to FIG. 6, the display device 510 according to the embodiment of the present invention may include a sensor 610, a controller 620, an output unit 630, and a memory unit 640.

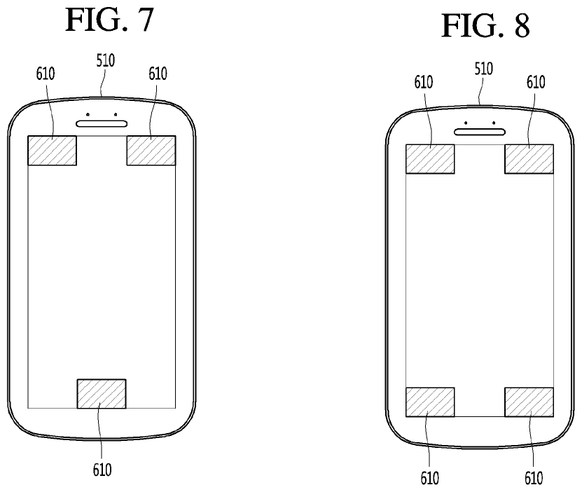

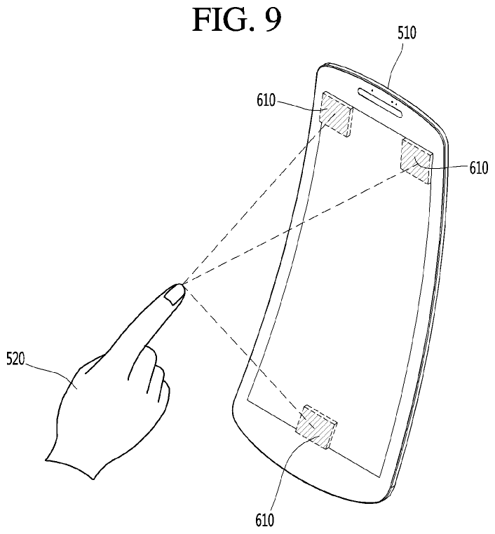

The sensor 610 may be provided with the display device 510 to sense the part 520 of the body of the user approaches the display device 510. The display device 510 may use the sensor 610 to detect at which position of the display device 510 the part 520 of the body of the user approaches the display device 510. To this end, at least three sensors 610 may be provided in the display device 510. For example, three sensors 610 may be provided in the display device 510 as illustrated in FIG. 7. In some embodiments, four sensors may be provided in the display devices 510 as illustrated in FIG. 8. In the following description, a case where three sensors 610 are provided in the display device 510 will be described as an example. At this time, the sensors 610 may be mounted at appropriate positions for detecting the position of the part 520 of the body of the user approaching the display device 510.

The one or more sensors 610 may include a signal transmission unit 611 that transmits ultrasonic and infrared signals so as to detect that the part 520 of the body of the user approaches the display device 510. The sensor 610 may include a signal reception unit 612 that receives a reflected wave signal that is transmitted from the signal transmission unit 611 and reflected by the part 520 of the body of the user.

The signal transmission unit 611 may transmit ultrasonic and infrared signals so as to detect whether the part 520 of the body of the user approaches the display device 510. When the part 520 of the body of the user approaches the display device 510, the signal transmission unit 611 may transmit the ultrasonic and infrared signals by adjusting the angle so that the transmitted ultrasonic wave is reflected from the part 520 of the body of the user and received by the signal reception unit 612.

The signal reception unit 612 may receive the reflected wave in which the ultrasonic and infrared signals transmitted from the signal transmission unit 611 are reflected from the part 520 of the body of the user approaching the display device 510. The signal reception unit 612 may analyze the received reflected wave and detect whether the part 520 of the body of the user approaches the display device 510. When the reflected wave signal is received, the signal reception unit 612 may calculate the level of the received reflected wave signal. When the level of the calculated reflected wave signal is greater than or equal to a predetermined reference signal level, the signal reception unit 612 may detect that the part 520 of the body of the user approaches the display device 510. When the signal reception unit 612 detects that the part 520 of the body of the user approaches the display device 510, the signal reception unit 612 may transmit information on the proximity sensing signal and the received reflected wave to the controller 620.

When the sensor 610 detects that the part 520 of the body of the user approaches the display device 510, the controller 620 may detect a button located at a position corresponding to the part 520 of the body of the user approaching the display device 510. It is possible to control the operation information signal of the detected button to be output. To this end, the controller 620 may include a button detection unit 621, an operable state detection unit 622, and a preceding button searching unit 623.

The button detection unit 621 may receive information on the proximity sensing signal and the reflected wave from the signal reception unit 612. When the proximity sensing signal is received from the signal reception unit 612, the button detection unit 621 may detect the button by using the information on the received reflected wave. At this time, the information on the reflected wave received from the signal reception unit 612 may include information on the reflected wave received by at least three sensors 610 provided in the display device 510. The button detection unit 621 can detect position information on the part 520 of the body of the user approaching the display device 510 by using at least three pieces of the information on the reflected wave.

The detection of the position information on the part 520 of the body of the user approaching the display device 510 may be performed by using at least three pieces of information on the reflected wave received from the signal reception unit 612. For example, when the ultrasonic signal collides with an object, signal deformation may occur at a position corresponding to a collision time point. Therefore, the position information on the part 520 of the body of the user may be detected by analyzing the received reflected wave signal. Alternatively, the position information on the part 520 of the body of the user may be detected by applying a triangulation method to at least three received reflected waves as illustrated in FIG. 8. In addition, any position detection methods other than the above-described method may also be applied as long as the position information on the part 520 of the body of the user can be detected by using the received reflected wave signal. On the other hand, the detected position information on the part 520 of the body of the user approaching the display device 510 may include (x, y, z) coordinate information.

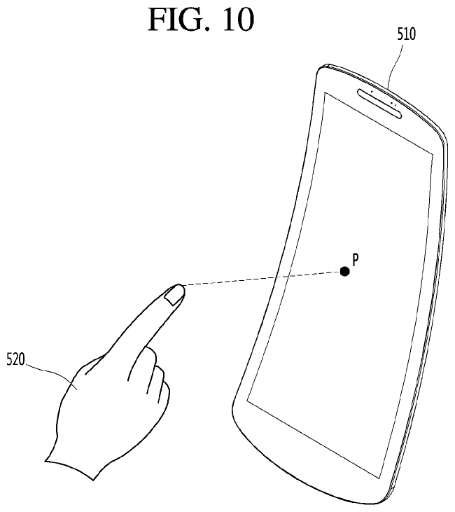

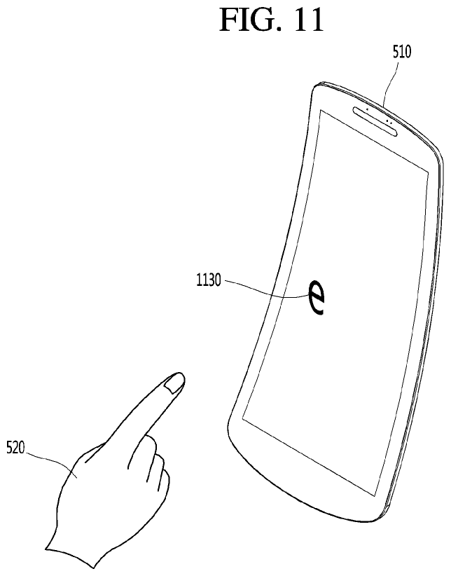

The button detection unit 621 may detect the detected position corresponding to the position of the part 520 of the body of the user approaching the display device 510 in the display device 510 as illustrated in FIG. 10. After detecting the corresponding position in the display device 510, the button detection unit 621 may detect the button closest to the position detected as illustrated in FIG. 11. At this time, the detection of the button closest to the detected position may be performed by using button position data in which the position information on the button is stored for each button.

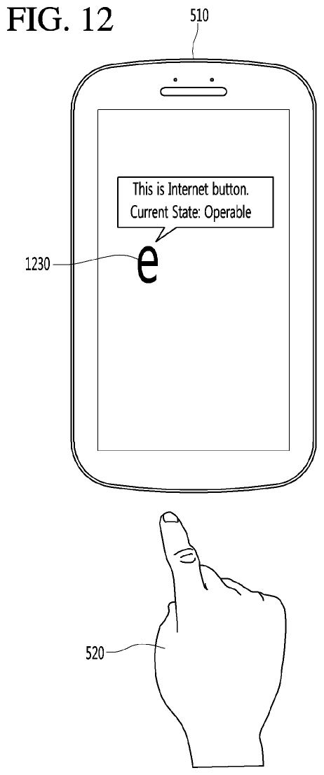

The operable state detection unit 622 may detect whether the button 1130 detected by the button detection unit 621 is currently in an operable state. At this time, this may corresponding to determining whether the function corresponding to the button 1130 is immediately executable when the user selects the button 1130 or performs a physical operation on the button 1130. When the button 1130 is in the operable state, the operable state detection unit 622 may control an operable notification signal to be output through the output unit 630. For example, when the operable state detection unit 622 detects that the button 1130 detected by the button detection unit 621 is an Internet button and the user is able to open an Internet window by touching or physically operating the Internet button since the network is currently connected, the operable state detection unit 622 may output an operable notification signal for the Internet button on the screen of the display device 510 as illustrated in FIG. 12.

The operable notification signal of the Internet button may include outputting a pop-up window indicating a message such as “This is Internet button. Current state: Operable” as illustrated in FIG. 12. On the other hand, when the state information for the corresponding button 1230 is searched for by the state information searching unit 624, the operable state detection unit 622 may control the state information to be output together with the operable notification signal.

A detailed description thereof will be described later with reference to the state information searching unit 624.

On the other hand, the operable notification signal may be output as a pop-up window that can be viewed through the display of the display device 510 as illustrated in FIG. 12, and may be output as a voice message that is audible through a speaker provided with the display device 510. Alternatively, the voice message may be output through the speaker at the same time that the pop-up window is displayed on the display of the display device 510.

The operable state detection unit 622 may transmit a search signal to the preceding button searching unit 623 when it is detected that the button 1230 detected by the button detection unit 621 is in a non-operable state.

The preceding button searching unit 623 may search for a preceding button to be operated before the operation of the corresponding button 1230 when the operable state detection unit 622 detects that the corresponding button 1230 is in a non-operable state. For example, when the button 1230 (Internet button) is detected as being non-operable by the operable state detection unit 622, the preceding button searching unit 623 may search for a network connection button as the preceding button of the Internet button. The preceding button searching unit 623 may search for the preceding button through the operation order data stored in advance in the memory unit 640. In this case, the operation order data may indicate an order in which the buttons are to be operated. For example, as described above, in order to operate the Internet button, the network connection button must be first operated to first establish connection to a network. Therefore, the operation order data for the Internet control button may include the “network connection button” in order to enable the Internet control button.

Similarly, there may be a button 1230 that is operable only when two or more preceding buttons are operated. For example, in order to operate an access button with another device, the network connection button must be first operated. Next, an access blocking release button may need to be operated. Since the access button with another device is to be operated next, the operation order data for the access button with the other device may include “access button with another device”.

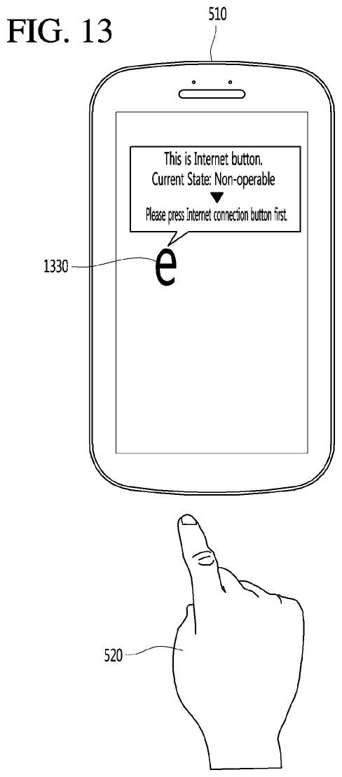

When the preceding button is searched for through the operation order data, the preceding button searching unit 623 may output an operation guide signal for the searched preceding button. At this time, the operation guide signal for the searched preceding button is a guide signal indicating the preceding button that must be operated to enable operation of the corresponding button 1330 when the user tries to (or is about to try to) operate the button 1330, as detected by the button detection unit 621. A notification voice message may include a notification signal indicating the preceding button or a message for operating the preceding button so that the user is guided to operate the preceding button to enable operation of the button 1330. For example, when the button 1330 to which the part 520 of the body of the user approaches is the Internet button, the Internet button is currently in a non-operable state, and the network connection button is searched for as the preceding button, the preceding button searching unit 623 may output, on the screen of the display device 510, a notification pop-up window indicating that the button detected by the button detection unit 621 is currently non-operable, and an operation guide signal for the preceding button as illustrated in FIG. 13.

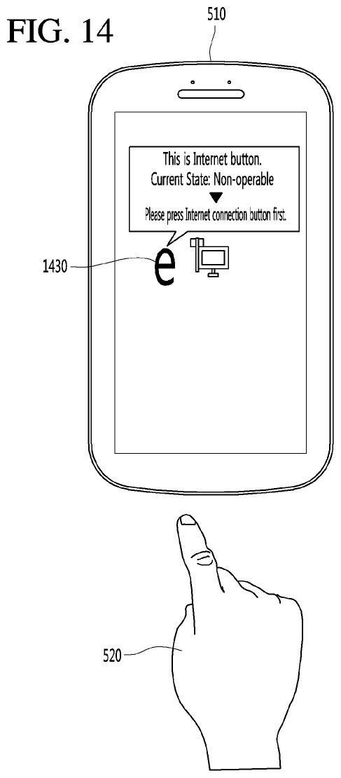

On the other hand, as illustrated in FIG. 14, the preceding button searching unit 623 may output, on the screen of the display device 510, a notification pop-up window indicating that the button detected by the button detection unit 621 is currently non-operable, and an operation guide for the preceding button. At the same time, the preceding button can be displayed on the screen of the display device 510, in some cases adjacent to the location of the button, so that the user may recognize the preceding button more easily.

The preceding button searching unit 623 may confirm whether the user operates the preceding button after the operation guide signal for the preceding button is output. When the user operates the preceding button, the preceding button searching unit 623 may output an operable notification signal for the button 1430 to which the part 520 of the body of the user first approaches. Therefore, the user may be guided to operate the button 1430 by outputting the operable notification signal for the button 1430 to which the part 520 of the body of the user first approaches, that is, the button 1430 that the user intends to operate.

On the other hand, when one preceding button for the button 1430 is searched for, the preceding button searching unit 623 may output the operable guide signal for the searched preceding button without having to set the output order. On the other hand, when two or more preceding buttons for the button 1430 are searched for, the output order may be important. When there are two or more preceding buttons, the preceding button searching unit 623 may output the operation guide signal for the preceding buttons according to the operation order stored in the operation order data. For example, the button 1430 to which the part 520 of the body of the user approaches may be an access button with another device. In the operation order data for the access button with another device, when there are two preceding buttons such as the “network connection button” and “access button with another device”, the preceding button searching unit 623 may output information for only the operation guide signal for the network connection button. When the network connection button is operated by the user, the preceding button searching unit 623 may then output the operation guide signal for the access blocking release button. When the access blocking release button is operated by the user, the preceding button searching unit 623 may perform a control so that the operable notification signal for the access button with another device is output.

The controller 620 according to another embodiment of the present invention may detect that the part 1520 of the body of the user approaches the display device 510 and output state information corresponding to the function of the button 1530 detected by the button detection unit 621. To this end, the controller 620 may include the state information searching unit 624.

The state information searching unit 624 may detect that the part 520 of the body of the user approaches the button 1530 by the sensor 610. In this case, it is possible to search whether there is state information that may be provided to the user in correspondence to the function of the button 1530 detected by the button detection unit 621. At this time, the state information corresponding to the function of the button 1530 may indicate information on a current state of the function of the button 1530 before the user operates the button 1530. For example, when the button 1530 is a volume control button (a volume up button or a volume down button), the state information corresponding to the function of the button 1530 may be a current volume level.

Meanwhile, the state information searching unit 624 may search whether there is state information corresponding to the function of the button 1530 by using button information data. When there is state information corresponding to the function of the button 1530, the button information data may include the latest state information corresponding to the button 1530 and store the latest state information. For example, the button information data of the volume up button and the volume down buttons may store the volume information as state information corresponding to the function of the button 1530. The state information may be periodically updated so as to maintain the latest state information, or may be newly detected when detecting the state information for the button 1530.

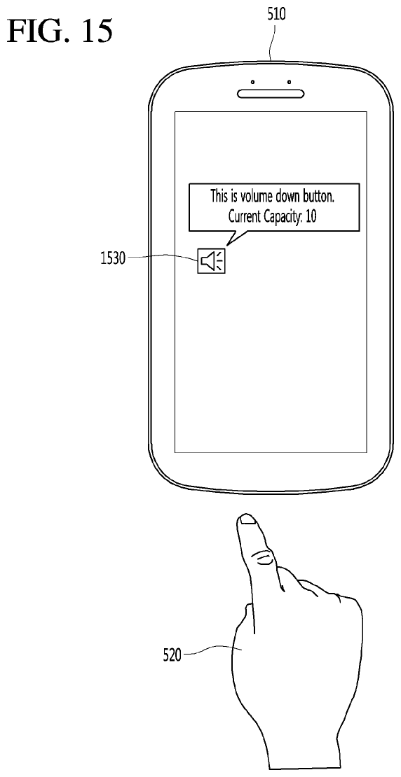

In order to provide the user with state information corresponding to the function of the button 1530, the state information searching unit 624 may output state information corresponding to the function of the button 1530 through the output unit 630 when the state information corresponding to the function of the button 530 exists. For example, as illustrated in FIG. 15, when the part 520 of the body of the user approaches the display device 510 and the volume down button is detected by the button detection unit 621, it is possible to search the volume information indicating that the current volume level is 10 and output the current volume level on the display of the display device 510.

The state information searching unit 624 may perform a control to output information indicating whether the button 1530 is in an operable state, together with the state information corresponding to the function of the button 1530 detected by the button detection unit 621.

The state information searching unit 624 may confirm whether state information exists corresponding to the function of the button 1530 detected by the button detection unit 621. It is possible to confirm whether the button 1530 is operable through the operable state detection unit 622. When the state information exists corresponding to the function of the button 1530 and it is confirmed that the button 1530 is in an operable state, the state information searching unit 624 may output, through the output unit 630, state information corresponding to the function of the button 1530 and an operable notification signal indicating that the button 1530 is currently operable.

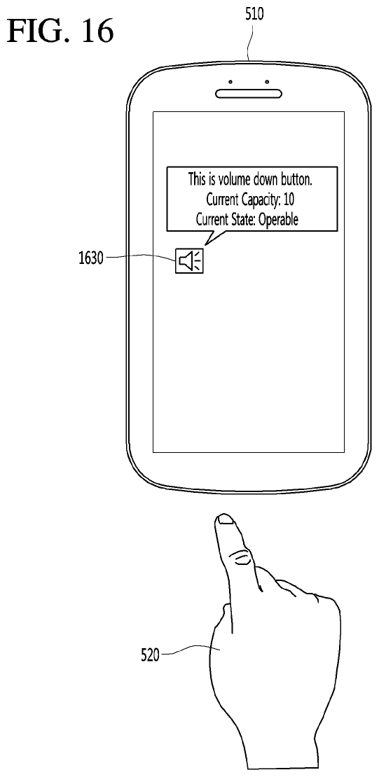

For example, when state information exists indicating that the button 1530 detected by the button detection unit 621 is the volume down button as the part 520 of the body of the user approaches the display device, and that the button is currently in an operable state, and the volume currently set to the speaker is 10, it is possible to output a message pop-up window “This is volume down button. Current volume: 10, Current state: Operable” on the screen of the display device 510 as illustrated in FIG. 16.

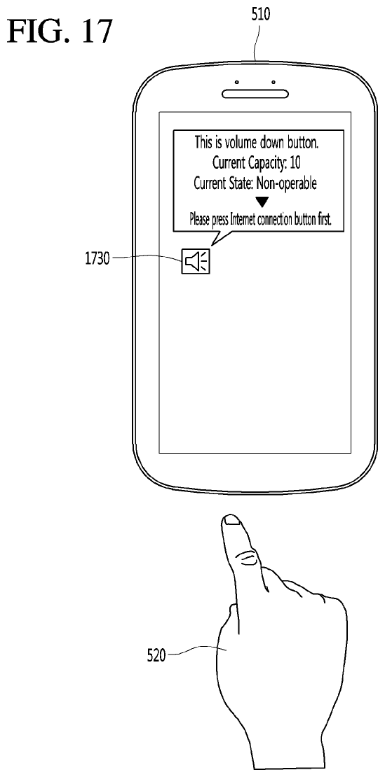

When state information exists corresponding to the function of the button 1630 detected by the button detection unit 621 when the part 520 of the body of the user approaches the display device and it is confirmed that the button 1630 is in a non-operable state, the state information searching unit 624 may control the preceding button searching unit 623 to search for a preceding button to be operated before the button 1630 so as to operate the button 1630. When the preceding button of the button 1630 is searched for, the state information searching unit 624 may perform a control to output operation guidance information indicating that the button 1630 is currently in a non-operable state and that the searched preceding button must be first operated so as to operate the button 1630, as well as state information corresponding to the function of the button 1630. For example, when the button 1630 is the volume down button and is currently in a non-operable state and the volume currently set to the speaker is 10, it is possible to output a message pop-up window “This is volume down button. Current volume: 10, Current state: Non-operable, Please press speaker power button first” on the screen of the display device 510 as illustrated in FIG. 17.

When there is no state information corresponding to the function of the button 1730 detected by the button detection unit 621 when the part 520 of the body of the user approaches the display device and it is confirmed that the button 1730 is in an operable state, the state information searching unit 624 may control only the operable notification signal of the button 1730 to be output.

When there is no state information corresponding to the function of the button 1730 detected by the button detection unit 621 when the part 520 of the body of the user approaches the display device and it is confirmed that the button 1730 is in a non-operable state, the state information searching unit 624 may control the preceding button searching unit 623 to search for a preceding button to be operated to enable operation of the button 1730. When the preceding button of the button 1730 is searched for, the state information searching unit 624 may control the operable guidance for the searched preceding button to be output.

On the other hand, the controller 620 according to another embodiment of the present invention may confirm that the preceding button has been operated by the user and that the function corresponding to the preceding button is activated, after the operation guidance for the searched preceding button is output. In this case, when it is confirmed that the preceding button has been operated by the user, it is possible to perform a control so that the operable notification signal of the button 1730 is output.

On the other hand, the state information on the button 1730 or the operation information signal of the button 1730 may be output as the message pop-up window that may be viewed through the display of the display device 510. When a speaker is provided with the display device 510, the voice message may be output as a voice message that is audible through the speaker. Alternatively, the voice message may be output through the speaker at the same time when the message pop-up window is displayed on the screen of the display device 510.

The output unit 630 may detect that the part 520 of the body of the user approaches the display device 510 and output the operation information signal for the button 1730 detected by the button detection unit 621 or the state information corresponding to the function of the button 1730. The output unit 630 may output the operation information signal for the button 1730 detected by the button detection unit 621 or the state information corresponding to the function of the button 1730 through the display of the display device 510. When a speaker is provided with the display device 510, the output unit 630 may output the operation information signal for the button 1730 detected by the button detection unit 621 or the state information corresponding to the function of the button 1730 as a voice signal.

The memory unit 640 may store a program for processing and control of the controller 620, and may perform a function for temporarily storing input/output data.

The memory unit 640 according to the embodiment of the present invention may store reference level data that may determine whether the part 520 of the body of the user approaches the button 1730. The memory unit 640 may store operation order data in which buttons to be operated so as to operate the arbitrary button 1730 are arranged and stored in order and button information data in which state information is classified for each button 1730 in which state information corresponding to the function is present.

For the purposes of this discussion, various operations are discussed as being performed by various modules, units, or components of robot, such as button detection unit, information searching unit, state information searching unit; preceding button searching unit, operable state detection unit, and the like. In some embodiments, a separate component of robot may be provided for one or more or each of the modules, units, or components to perform the disclosed operations. However it will also be understood that these and other components of this disclosure may be implemented with or as one or more hardware controllers or processors of the robot executing stored software instructions corresponding to the operations, or that one or more or all of the operations discussed with respect to these components may be performed by other aspects of robot, such as the one or more controllers or processors of the robot. Further, it will be understood that one or more or all of these operations may be performed via other means, including other terminals or apparatuses configured to perform the operations which are in communication with robot and configured to provide information resulting from said operations to the robot for further processing or use.

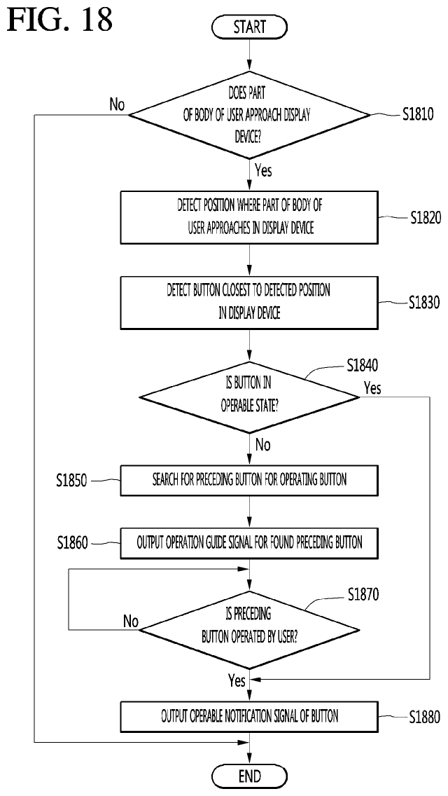

Hereinafter, a control method using proximity sensing according to an embodiment of the present invention will be described with reference to FIG. 18.

First, it is confirmed through the sensor 610 whether the part 520 of the body of the user approaches the button 1130 (S1810).

At this time, confirming through the sensor 610 whether the part 520 of the body of the user approaches the button 1130 may include transmitting the ultrasonic wave and the infrared ray through the signal transmission unit 611 provided inside the button, as previously discussed. The reflected wave obtained when the transmitted ultrasonic wave and infrared ray is reflected from the part 520 of the body of the user, and whether the part 520 of the body of the user approaches the button 1130 may be determined by confirming whether the signal level of the received reflected wave is greater than or equal to a predetermined reference signal level.

When it is determined that the part 520 of the body of the user approaches the button 1130 (S1810), the received reflected wave signal is analyzed to detect the position where the part 520 of the body of the user approaches the display device 510 (S1820).

At this time, it is possible to detect the position where the part 520 of the body of the user approaches by analyzing that the received reflected wave signal is deformed by colliding with the part 520 of the body of the user. Alternatively, the triangulation method may be applied to at least three reflected wave signals received by at least three sensors 610 to detect the position where the part 520 of the body of the user approaches, as previously discussed.

After detecting the position on the display where the part 520 of the body of the user approaches (S1820), the button 1130 closest to the detected position on the display device 510 may be detected (S1830).

After detecting the button 1130 (S1830), whether the button 1130 is in an operable state is determined so that the user may be informed whether the button 1130 is operable (S1840).

When it is determined that the button 1130 is in a non-operable state (S1840), the preceding button required to enable operation of the button 1130 is searched for to guide the user about the required operations for operating the button 1130 (S1850).

After searching for the preceding button for operating the button 1130 (S1850), the operation guidance for the searched preceding button is output (S1860), so that the user is provided with guide information for operating the preceding button 1130.

At this time, the operation guidance for the preceding button may include a guide message, position information of the preceding button, or operation method information so that the user is informed on operating the preceding button to enable operation of the button 1130.

After the operation guidance for the preceding button is output (S1860), it is determined whether the function of the preceding button is activated by the user, that is, whether the user has operated the preceding button (S1870).

At this time, when it is determined that the preceding button has not been operated by the user (S1870), the method may include checking or confirming, continuously or at certain intervals, whether the preceding button has been operated by the user.

In addition, when it is determined that the preceding button has been operated by the user (S1870), the operable notification signal for the button 1130 is output indicating that the button 1130 is in an operable state (S1880).

When it is determined that the button 1130 is in the operable state (S1840), the operable notification signal for the button 1130 is output indicating that the button 1130 is in an operable state (S1880).

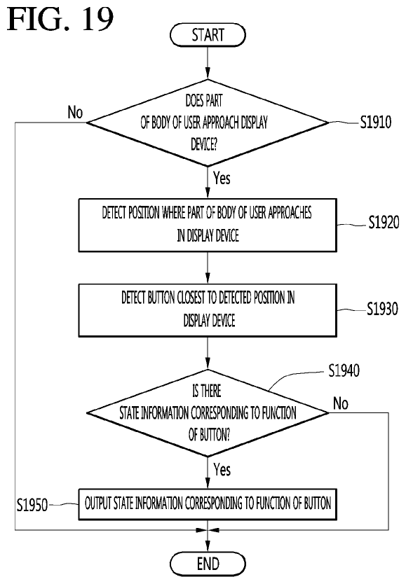

Hereinafter, a control method using proximity sensing according to another embodiment of the present invention will be described with reference to FIG. 19.

First, it is determined through the sensor 610 whether the part 520 of the body of the user approaches the button 1130 (S1910).

When it is determined that the part 520 of the body of the user approaches the button 1130 (S1910), the received reflected wave signal is analyzed to detect the position of the display where the part 520 of the body of the user approaches the display device 510 (S1920).

After detecting the position where the part 520 of the body of the user approaches (S1920), the button 1130 closest to the detected position on the display device 510 is detected (S1930).

After the button 1130 closest to the detected position on the display device 510 is detected (S1930), it is determined whether there is state information corresponding to the function of the button 1130 (S1940).

At this time, the state information corresponding to the function of the button 1130 may indicate information on the currently set state corresponding to the function of the button 1130, which may be provided before the user operates the button 1130. The state information corresponding to the function of the button 1130 may be classified and stored for each button 1130 in the memory unit 640.

When state information exists corresponding to the function of the button 1130 (S1940), the state information is output through the output unit 630 (S1950).

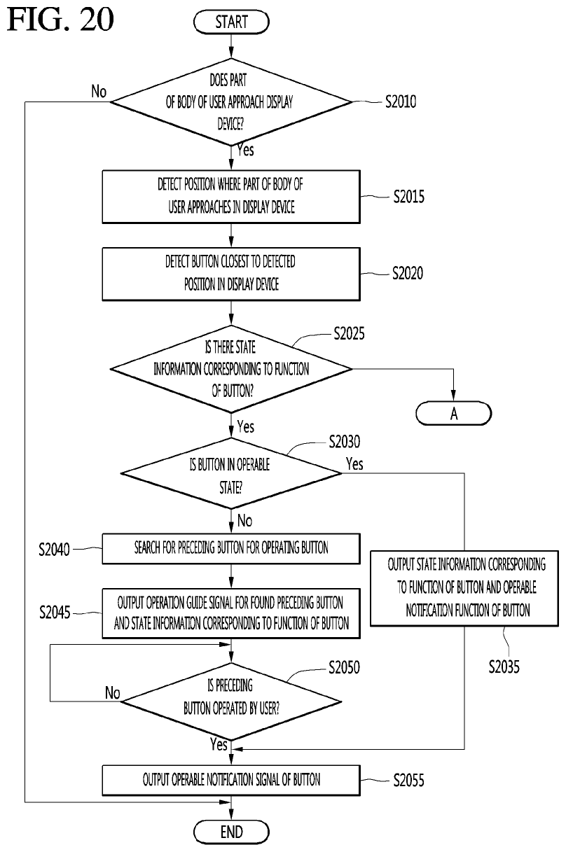

Hereinafter, a control method using proximity sensing according to another embodiment of the present invention will be described with reference to FIG. 20.

When state information corresponding to the function of the button 1130 is provided to the user, the display device 510 according to another embodiment of the present invention may also provide a signal as to whether the button 1130 is currently operable.

To this end, first, it is determined through the sensor 610 whether the part 520 of the body of the user approaches the button 1130 (S2010). When it is determined that the part 520 of the body of the user approaches the button 1130 (S2010), the received reflected wave signal is analyzed to detect the position on the display where the part 520 of the body of the user approaches the display device 510 (S2015). The button 1130 closest to the position detected on the display device 510 is detected (S2020). It is determined whether state information exists corresponding to the function of the button 1130 (S2025). When the state information exists corresponding to the function of the button 1130, it is determined whether the button 1130 is in an operable state (S2030).

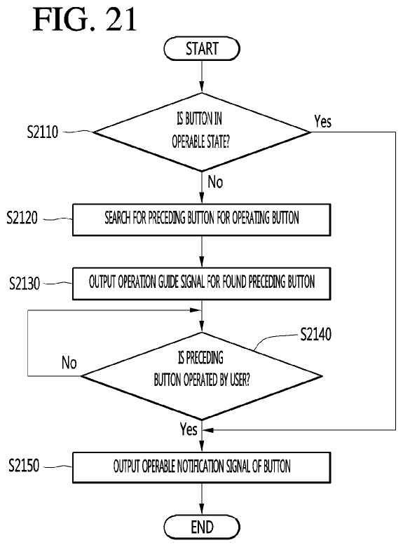

An example of the embodiment where there is no state information corresponding to the function of the button 1130 will be described later with reference to FIG. 21.

When it is determined that the button 1130 is in the operable state (S2030), the state information corresponding to the function of the button 1130 and the operable notification signal of the button 1130 are output together (S2035).

When it is determined that the button 1130 is in a non-operable state (S2030), the preceding button required to be previously operated to enable operation of the button 1130 is searched for in order to inform the user about the required action for operating the button 1130 (S2040).

After searching for the preceding button (S2040), the operation guidance for the searched preceding button is output together with the state information corresponding to the function of the button 1130 (S2045).

At this time, the operation guidance for the preceding button may include a guide message, position information of the preceding button, and operation method information indicating that the user must first operate the preceding button to enable operation of the button 1130.

After the state information corresponding to the function of the button 1130 and the operation guidance for the preceding button is output (S2045), it is determined whether the function of the preceding button has been activated by the user, that is, whether the user has operated the preceding button (S2050).

When it is determined that the preceding button has not been operated by the user (S2050), the method may include checking or confirming, continuously or at certain intervals, whether the preceding button has been operated by the user.

When it is determined that the preceding button has been operated by the user (S2050), the operable notification signal for the button 1130 is output indicating that the button 1130 is in an operable state (S2055).

Hereinafter, when there is no state information corresponding to the function of the button, a display control method using proximity sensing according to another embodiment of the present invention will be described with reference to FIG. 20.

First, when the part 520 of the body of the user is detected as being close and there is no state information corresponding to the function of the button 1130 detected by the button detection unit 621, it is confirmed whether the button 1130 is in an operable state (S2181).

At this time, when it is determined that the button 1130 is in the non-operable state (S2181), the preceding button required to be previously operated to enable operation of the button 1130 is searched for to notify the user on how to enable operation of the button 1130 (S2120).

After searching for the preceding button (S2120), the operation guidance for the searched preceding button is output together with the state information corresponding to the function of the button 1130 (S2130).

At this time, the operation guidance for the preceding button may include a guide message, position information of the preceding button, or operation method information indicating that the user must first operate the preceding button to enable operation of the button 1130.

After the state information corresponding to the function of the button 1130 and the operation guidance for the preceding button is output (S2130), it is determined whether the function of the preceding button has been activated by the user, that is, whether the user has operated the preceding button (S2140).

At this time, when it is determined that the preceding button has not been operated by the user (S2140), the method may include checking or confirming, continuously or at certain intervals, whether the preceding button has been operated by the user.

In addition, when it is determined that the preceding button has been operated by the user (S2140), the operable notification signal for the button 1130 is output to indicate that the button 1130 is in an operable state (S2150).

On the other hand, when it is determined that the button 1130 is in the operable state (S2110), the operable notification signal for the button 1130 is output indicating that the button 1130 is in an operable state (S2150).

Such a control technique using proximity recognition may be implemented in an application or may be implemented in the form of program instructions that can be executed through various computer components and recorded in a computer-readable recording medium. The computer-readable recording medium may include program instructions, data files, data structures, and the like solely or in combination.

The various devices, modules, terminals, and the like discussed herein may be implemented on a computer by execution of software comprising machine instructions read from non-transitory computer-readable medium. Non-transitory computer readable medium may refer to any medium that participates in holding instructions for execution by the processor, or that stores data for processing by a computer, and comprise all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In certain embodiments, several hardware aspects may be implemented using a single computer, terminal, or apparatus, in other embodiments multiple computers, input/output systems and hardware may be used to implement the system. For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

The foregoing disclosed embodiments and features are merely exemplary and are not to be construed as limiting the present invention. The present teachings can be readily applied to other types of apparatuses and processes. The description of such embodiments is intended to be illustrative, and not to limit the scope of the claims. Many alternatives, modifications, and variations will be apparent to those skilled in the art.

1-14. (canceled)

15. A robot comprising:
a display unit configured to display information;
a sensor; and
one or more processors configured to:
detect an object proximately positioned from the display unit via the sensor;
determine a first position associated with the detected object relative to the display unit;
display, via the display unit, first information for the detected object at the determined first position; and
display, via the display unit, second information for the detected object at a second position on the display unit,
wherein the displayed second information comprises a button associated with the displayed first information.

16. The robot of claim 15, wherein the one or more processors are further configured to obtain the displayed second information based on a search using the first information.

17. The robot of claim 15, wherein the one or more processors are further configured to:
determine whether a function corresponding to the second information is in an operable state; and
cause the function to be executed in response to selection of the button while the function is in the operable state.

18. The robot of claim 17, wherein the one or more processors are further configured to display, via the display unit, a notification regarding operability of the function when the function is determined to be operable.

19. The robot of claim 17, wherein the one or more processors are further configured to determine one or more operations required to place the function in the operable state when the function is determined to be non-operable.

20. The robot of claim 19, wherein the one or more operations comprises enabling of a second function performed by selecting a second button resulting in the function being enabled to the operable state.

21. The robot of claim 20, the one or more processors are further configured to output guidance information providing information on enabling the second function by selecting the second button for enabling the function to the operable state.

22. The robot of claim 15, comprising at least three sensors configured to detect a distance of the detected object from the display unit and a position of the detected object relative to the display unit.

23. The robot of claim 22, wherein the at least three sensors are implemented in the display unit.

24. A machine-readable non-transitory medium having stored thereon machine-executable instructions for controlling a robot, the instructions comprising:
detecting an object proximately positioned from the display unit;
determining a first position associated with the detected object relative to the display unit;
displaying, via a display unit of the robot, first information for the detected object at the determined first position; and
displaying, via the display unit, second information for the detected object at a second position on the display unit,
wherein the displayed second information comprises a button associated with the displayed first information.

25. The machine-readable non-transitory medium of claim 24 wherein the instructions further comprise obtaining the displayed second information based on a search using the first information.

26. The machine-readable non-transitory medium of claim 24 wherein the instructions further comprise:
determining whether a function corresponding to the second information is in an operable state; and
causing the function to be executed in response to selection of the button while the function is in the operable state.

27. The machine-readable non-transitory medium of claim 26 wherein the instructions further comprise displaying a notification regarding operability of the function when the function is determined to be operable.

28. The machine-readable non-transitory medium of claim 26 wherein the instructions further comprise determining one or more operations required to place the function in the operable state when the function is determined to be non-operable.

29. The machine-readable non-transitory medium of claim 28 wherein the one or more operations comprises enabling of a second function performed by selecting a second button resulting in the function being enabled to the operable state.

30. The machine-readable non-transitory medium of claim 29 wherein the instructions further comprise outputting guidance information providing information on enabling the second function by selecting the second button for enabling the function to the operable state.

31. The machine-readable non-transitory medium of claim 24 wherein the distance of the detected object from the display unit and a position of the detected object relative to the display unit are detected via at least three sensors of the robot.

32. The machine-readable non-transitory medium of claim 31 wherein the at least three sensors are implemented in the display unit.

33. An electronic terminal comprising:
a display;
one or more sensors; and
one or more processors configured to:
detect an object proximately positioned from the display unit via the one or more sensors;
determine a first position associated with the detected object relative to the display;
display, via the display, first information for the detected object at the determined first position; and
display, via the display, second information for the detected object at a second position on the display,
wherein the displayed second information comprises a button associated with the displayed first information.

34. The electronic terminal of claim 33, wherein the one or more processors are further configured to obtain the displayed second information based on a search using the first information.
